(19) United States
(12) Patent Application Publication
(10) Pub. No.: US 2007/0279908 A1
(43) Pub. Date: Dec. 6, 2007

(54) General Lighting Armature

(76) Inventor: Turhan Alcelik, Balgat (TR)

Correspondence Address: AKERMAN SENTERFITT, P.O. BOX 3188, WEST PALM BEACH, FL, 33402-3188, US

(21) Appl. No.: 11/574,385

(22) PCT Filed: Aug. 26, 2005
(86) PCT No.: PCT/TR05/00037

§ 371 Date: Jul. 31, 2007

(30) Foreign Application Priority Data
Aug. 27, 2004 (TR) 2004/02155
Aug. 22, 2005 (TR) 2005/03337

(51) Int. Cl. F21V 7/00; F21V 15/01

(52) U.S. Cl. 362/283; 362/296; 362/362

(57) ABSTRACT

This invention relates generally to all indoor and outdoor lighting systems, specifically to an armature (1) containing a reflective surface and light source that can be used in indoor and outdoor lighting systems as well as in road illumination systems where intensive uniform illumination is required without glaring effect, containing at least one reflective surface (2) and a light source. The reflective surfaces (2) to be used with the armature (1) hereunder are divided into two groups depending on the light source they use. These are; a hog-backed (6) reflector with longitudinal channels (8) and latitudinal channels (10), using a stepped light source (3), and a multi-angle reflector (11) using a linear light source (12).

### BACKGROUND OF THE INVENTION

1. Field of the Invention

This invention relates generally to all indoor and outdoor lighting systems, specifically to an armature containing a reflective surface and light source that can be used in indoor and outdoor lighting systems as well as in road illumination systems where intensive illumination is required without glaring effect.

The general lighting armatures hereunder have been developed for use in illumination systems for roads, junctions, bridges and tunnels, open and closed sports fields, industrial areas, inside and outside of factories and workshops, airports, train stations, parking areas, petrol stations, open and closed storage areas, shopping centers and in similar large area illumination systems, architectural illumination and security illumination systems, and the armatures in question can be used in illumination systems for all open and closed limited areas by making necessary modifications on their reflective surfaces and light sources.

2. Detailed Description of the Prior Art

The illumination technique widely used in illumination of open and closed large areas and road illumination is based on the light produced directly reaching to the illumination zone and reflection of the light to the required parts of the illumination zone by means of symmetrical or asymmetrical reflectors having smooth or rough reflective surfaces. The light sources generally used in such type of armatures and floodlights are high-pressure sodium vapor bulbs, mercury vapor bulbs, metal halide bulbs, fluorescent bulbs, and incandescent filament bulbs and LEDs (Light Emitting Diode).

Such type of general lighting armatures and floodlights has many disadvantages, although they are used widely: The main disadvantages and problems involved in these systems are inhomogeneous illumination in the area to be illuminated, glaring effect on eyes and energy loss caused by inefficient use of energy resulting in a significant economic loss.

The main reason of insufficient and inhomogeneous illumination is the loss of the light produced partly in the armature or floodlight and partly in the space, that the reflected light beams can not be oriented properly, and uncontrolled light scattering outside the proposed illumination area and into air.

The uncontrolled light scattering is also the main reason of glaring effect and energy loss.

In illumination of sports fields, sensitive working environments, road and security illumination where intensive illumination is required, increasing the number of armatures or projectors or using powerful light sources increases not only the glaring effect but also the costs.

The glaring effect caused by widely used standard general lighting armatures is factor that decreases visual quality, efficiency of the work done, and also increases the costs.

Many modifications have been made on armature components in order to avoid glaring effect and energy loss caused by this type of general lighting armatures. Some of these modifications are: formation of multi-surface parts on reflective surfaces having different reflection angles; any painting and coating operations on bulb tubes, enclosure glass (front lens) or reflective surface; or additional light guiding or blocking sheets attached inside and outside of the floodlights.

Some of the patents acquired as examples of the studies in the past are; the U.S. Pat. Nos. 654,208 for Washburn and Tinkham, 1,258,007 for Hess, 1,286,535 for Cochran, 1,305,837 for Sedano, 1,347,268 and 1,555,410 for Godley, 1,480,904 for Halvorson, 2,089,610 for Kloos, 3,530,287 for Husby, 3,835,342 for Freeman, 4,081,667 for Lewin wet al., 4,096,555 for Lasker, 4,153,929 for Laudenschlarger et al., 4,218,727 for Shemitz et al., 4,231,080 for Compton, 4,254,456 for Grindle et al., 4,293,901 and 4,531,180 for Hernandez, 4,360,863 for Barnes et al., 4,388,680 for Moore, 4,447,865 for VanHorn et al., 4,484,254 for Puckett et al., 4,587,601 for Collins, 4,706,173 for Hamada et al., 4,799,136 for Molnar, 4,725,934 and 5,707,142 for Gordin, 4,864,476 and 5,313,379 for Lemons et al., 4,943,901 and 5,586,015 for Baldwin et al., 4,994,947 for Fesko, 5,014,175 for Osteen et al., 5,582,479 for Thomas et al., 5,730,521 for Spink et al., 5,803,593 and 6,217,197 for Siminovitch et al., 5,895,114 for Thornton, 5,964,522 for Schaefer et al., 6,086,227 for O'Connell et al., 6,102,555 for Mizoguchi, 6,361,175 for Kittelmann et al., 6,419,375 for Leadford et al., 6,419,378 for Wedel et al., 6,454,433 for Alessio, 6,494,596 for Burroughs, 6,703,799 for Summerford et al., 6,744,187 for Wimberly, and the JP patents of 07-320516 for Oshiro Yutaka, and 07-320515 for Ono Hiroko and Asanuma Takashi.

Furthermore, the patent applications no. U.S. Pat. No. 5,272,408 US, 1481938 GB and 1347338 GB for the studies in a similar field are also known in addition to the above mentioned studies.

In most of the previous studies for which a few examples are given above; the technical characteristics of the reflector types and standard light sources used as well as the positions of light sources in the standard armature could not provide sufficient photometric performance and could not achieve a fully homogeneous illumination on the proposed area even the light is guided to some extent by modifications on the reflective surfaces, and caused uncontrolled light scattering and thereby causing significant energy loss and glaring effect.

Particularly for road illumination, the reflection technique in standard armatures is that the reflective surfaces illuminate, depending on their positions in the armature, the opposite side of the road section to be illuminated. Therefore, the light beams reflecting from every point of reflective surfaces on the opposite direction which are visible even at longer distances and reaching at the drivers' eyes in an uncontrolled manner cause the driver or an observer to look towards the armature. This phenomenon is called preferential looking effect. The preferential looking effect is defined as the phenomenon in which the eyes involuntarily tend to look at a moving object or an object which is brighter than the existing environment. The eye voluntarily gets far away from such object later on. However, the preferential looking effect caused by the armature which is brighter than the road illumination is an important source of glaring particularly during nighttime driving, and disturbs vision.

All painting and coating operations on the light sources and reflectors and additional reflective surfaces and light obstructing sheets attached to inside or outside of the floodlights in order to avoid the glaring effect caused by uncontrolled light scattering decreases the photometric performance of the armatures and causes a significant energy loss, as they partly block the light beams or guide them outside the area to be illuminated. Particularly, the sheets attached outside the floodlights not only decrease the photometric performance but also decrease the resistance to wind in outdoor applications, thereby causing damage to the armature.

In most of these applications, the glaring effect can not be controlled effectively due to technical characteristics and positioning of standard light sources used and the light reflecting mechanisms of these surfaces.

### BRIEF DESCRIPTION OF THE INVENTION

The purpose of this invention is to develop a general illumination technique, maximizing the photometric performance by using the light produced in the light source for illumination in the most efficient way.

Another purpose of the invention is to obtain a lighting armature causing a minimum glaring effect by making smaller and distributing the image of the light source on the reflector.

Another purpose of the illumination technique hereunder is to enable the reflective surfaces of the armature to illuminate the area in which they are positioned, thereby enabling illumination without use of reverse reflection mechanism which is a major reason of glaring.

Another purpose of the invention is to develop an illumination technique providing a controlled homogeneous illumination at uniform light intensity by guiding the light at optimum reflection angles through modifications on the size and positions of the armature and reflective surfaces depending on the width and length of the area to be illuminated.

Another purpose of the general illumination technique hereunder is to decrease the cost of installation and use while providing sufficient illumination by decreasing the number of floodlights or armatures and using low power consuming light sources.

### DETAILED DESCRIPTION OF THE INVENTION

A few preferred applications using the armatures developed to achieve the objectives of this invention are illustrated in the figures attached hereto, and these figures are listed below:

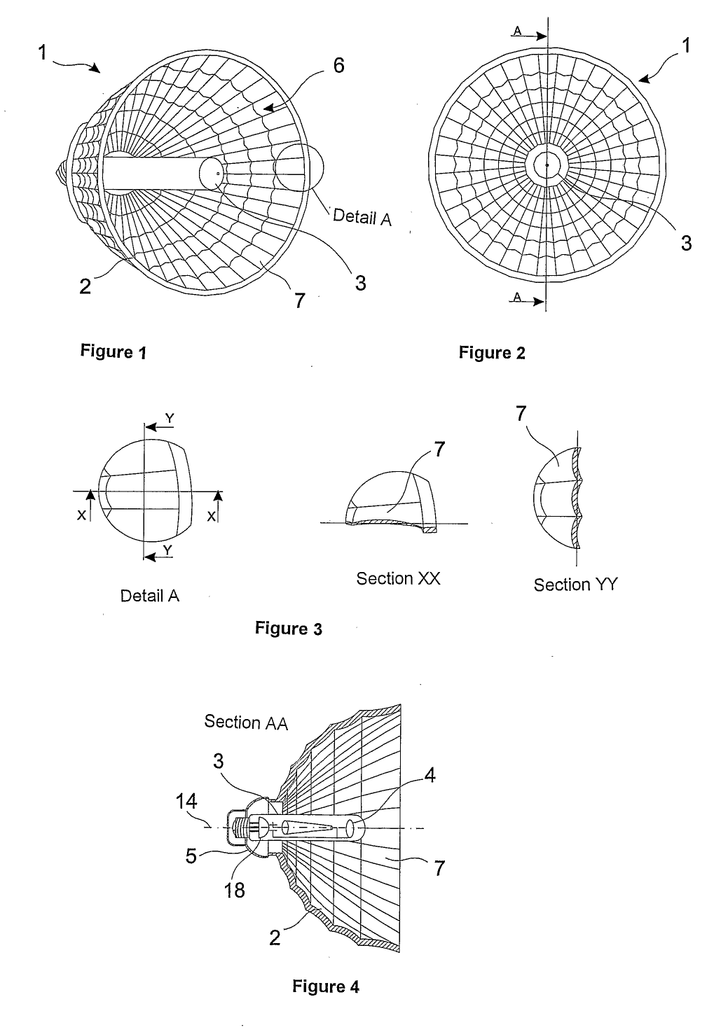

FIG. 1—Perspective view of the armature having hog-backed reflective surface.

FIG. 2—Front view of the armature having hog-backed reflective surface.

FIG. 3—Detailed perspective view of the armature having hog-backed reflective surface and sections XX and YY of this view.

FIG. 4—Section AA of the armature having hog-backed reflective surface.

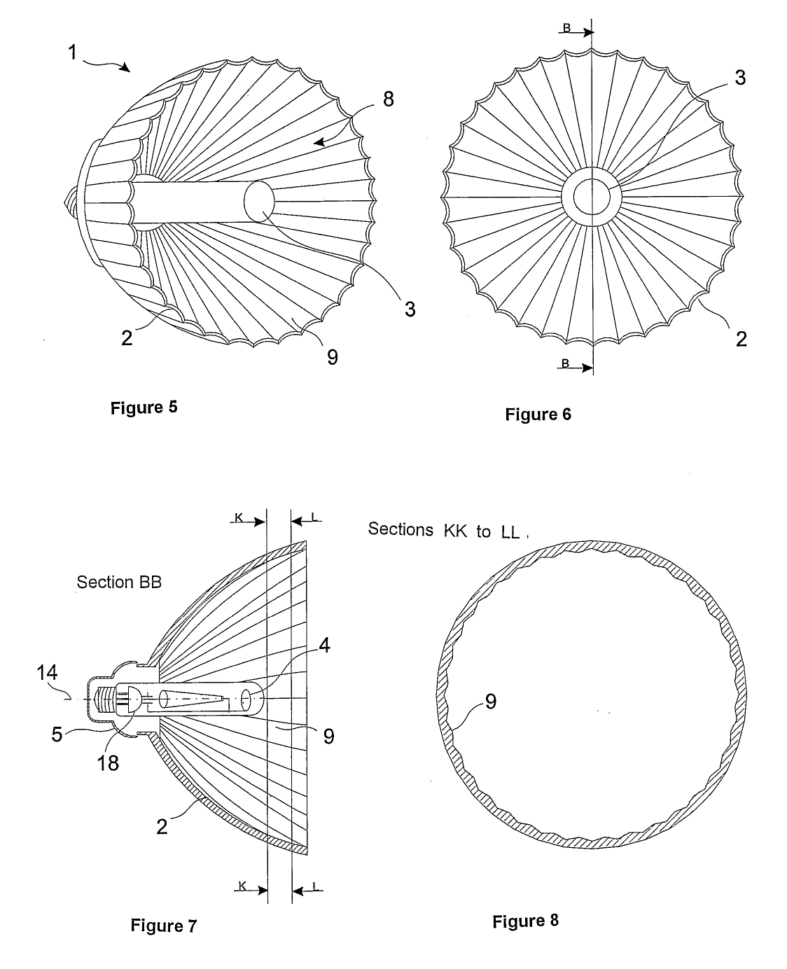

FIG. 5—Perspective view of the armature having a convex reflective surface with longitudinal channel.

FIG. 6—Front view of the armature having a convex reflective surface with longitudinal channel.

FIG. 7—Section BB of the armature having a convex reflective surface with longitudinal channel.

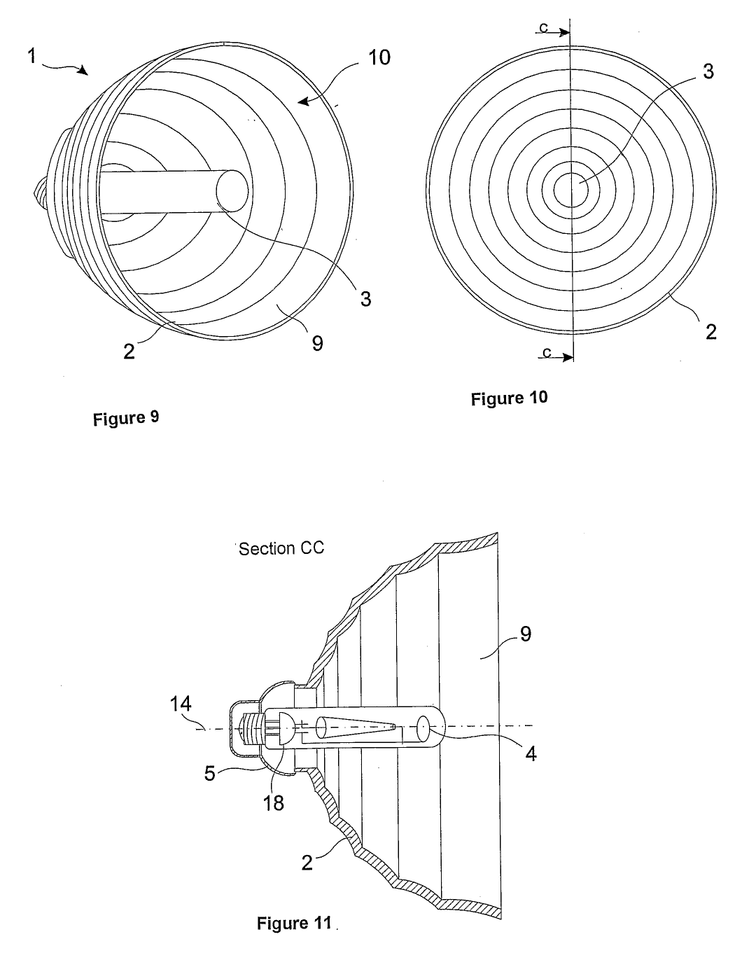

FIG. 8—Section KK-LL of the armature having a convex reflective surface with longitudinal channel.

FIG. 9—Perspective view of the armature having a convex reflective surface with latitudinal channel.

FIG. 10—Front view of the armature having a convex reflective surface with latitudinal channel.

FIG. 11—Section CC of the armature having a convex reflective surface with latitudinal channel.

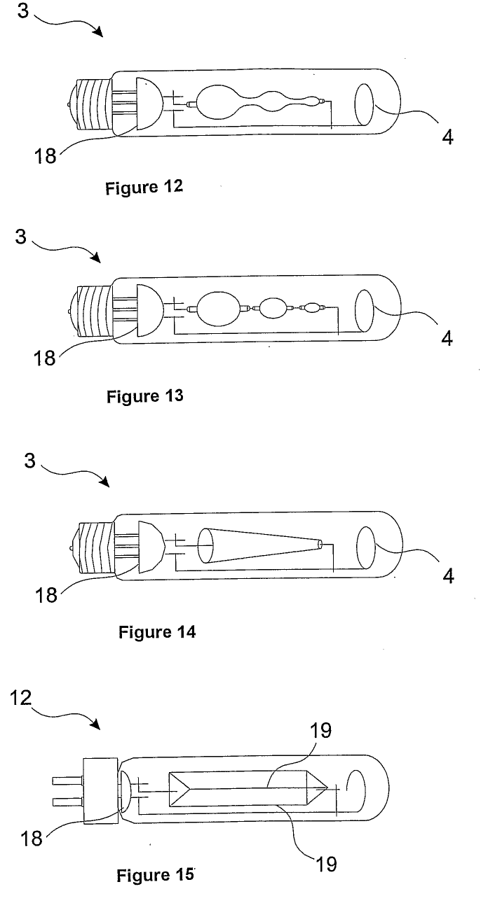

FIG. 12—View of stepped light source with two-node gas discharge tube having a single gas discharge opening that can be used with the armature hereunder.

FIG. 13—View of nodded gas discharged stepped light source having three gas discharge openings that can be used with the armature hereunder.

FIG. 14—View of stepped light source with conical arc tube that can be used with the armature hereunder.

FIG. 15—View of stepped linear light source that can be used with the armature containing multi-angle reflector.

FIG. 16—Perspective view of multi-angle reflector.

FIG. 17—Front view of multi-angle reflector.

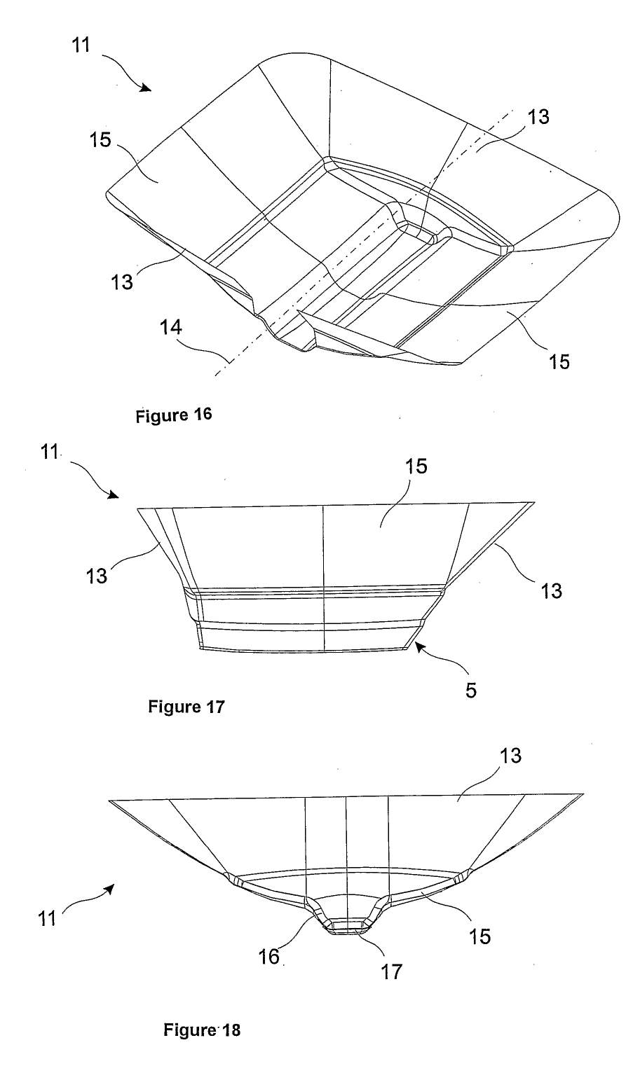

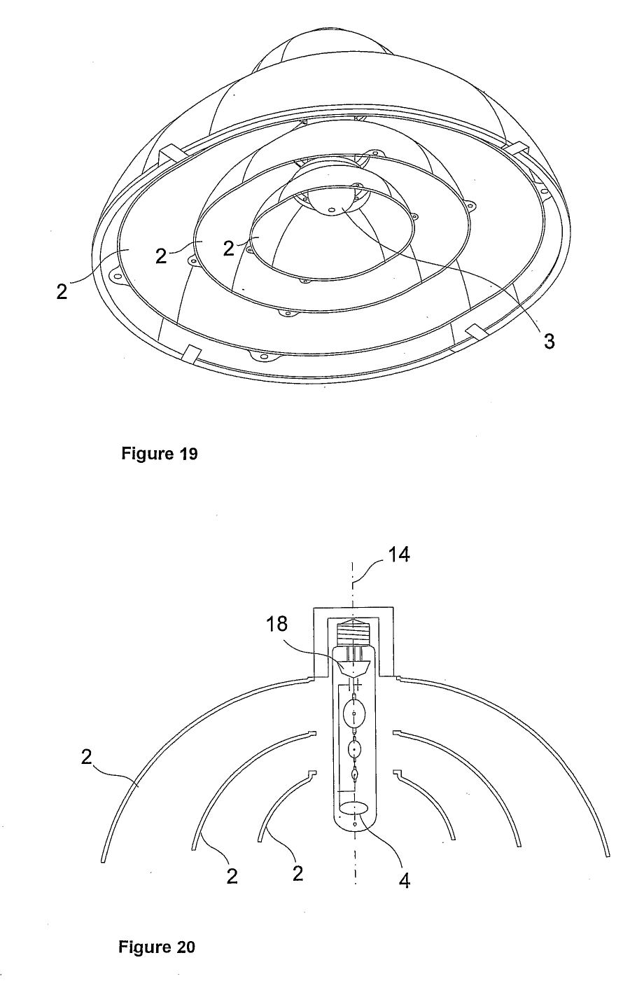

FIG. 18—Side view of multi-angle reflector.

FIG. 19—Perspective view of the armature containing sequential reflectors.

FIG. 20—Sectional view of the armature containing sequential reflectors with stepped light source with three gas discharge tubes.

FIG. 21—Sectional view of the armature containing sequential reflectors with light source with conical arc tube.

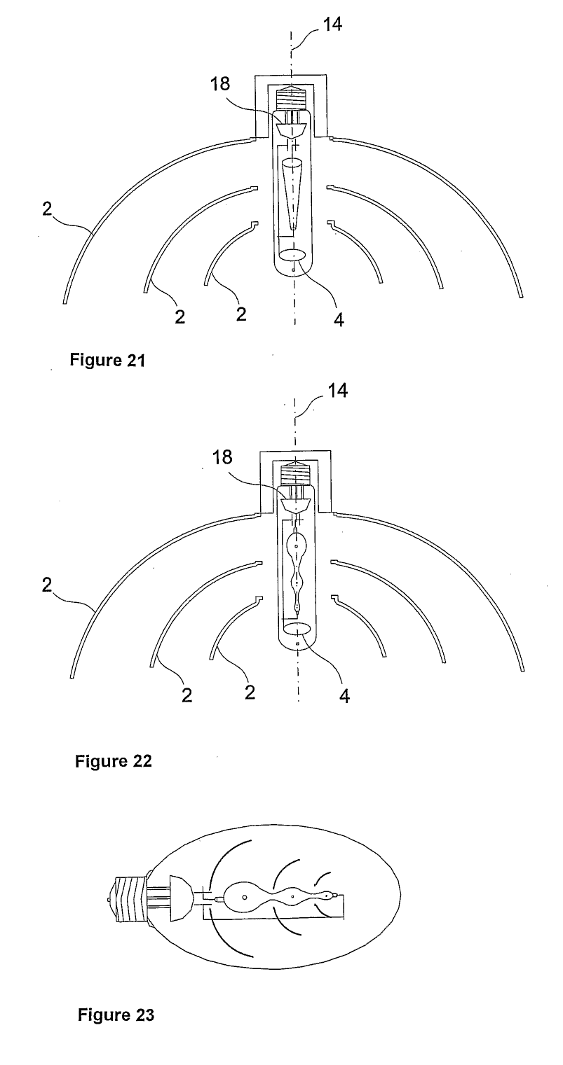

FIG. 22—Sectional view of the armature containing sequential reflectors with stepped light source with two-node gas discharge tube.

FIG. 23—Schematic view of stepped light source with two-node gas discharge tube, in which the sequential reflectors are mounted inside the light source.

Each component is numbered in the figures, and the component corresponding to each number is listed below.
1. Armature
2. Reflective surface
3. Stepped light source
4. Front reflector
5. Auxiliary reflector
6. Hog-backed surface
7. Mound
8. Longitudinally channeled surface
9. Corrugation
10. Latitudinal channeled surface
11. Multi-angle reflector
12. Linear light source
13. Panel
14. Illumination axis
15. Concave reflector
16. Auxiliary concave reflector
17. Auxiliary convex reflector
18. Rear internal reflector
19. Intersection

The armature (1) hereunder, in its very basic structure, contains at least one reflective surface (2) and a stepped light source (3) or a linear light source (12). Furthermore, the reflective surfaces to be used in the armature hereunder have two different basic structures depending on the light source they use. These are hog-backed reflector (6) using a stepped light source (3), and the multi-angle reflector (11) using a linear light source (12) with longitudinal channels (8) and latitudinal channels (10). Furthermore, it is possible to attach at least one auxiliary reflector (5) and a rear internal reflector (18) inside the stepped light source (3) in order to minimize the energy loss, and to place a front reflector (4) front inside or outside of the light source (3) in question in order to decrease the glaring effect.

The reflective surfaces (2) contain convex corrugations or mounds as ell as concave indents, cavities, channels and slots to provide a homogeneous illumination at a uniform light intensity without glaring effect. The hog-backed reflective surface (6), which is the first out of the two reflective surfaces (2) in question, is a preferably convex mound (7) covering inside surface of the armature (1). As well as the positioning of the mounds (7) may be spiral starting from the center of the armature, it may also be in the form of longitudes and latitudes assuming the armature (1) center as polar point. The base of each mound (7) may be rectangular or in any geometry that can cover the internal surface. The light beams from the stepped light source (3) are guided to the external opening of the reflective surface (2) without being back reflected inside the armature (1) by virtue of height and base area of the mound (7) getting smaller as approaching to the armature center (1).

The longitudinal channel (8), which is the other reflective surface (2), consists of the channels laid in the same direction with the optical axis of the armature (1) and convex corrugations (9). The corrugations are arranged in the form of longitudes assuming the armature (1) center as the polar point. Therefore, the width of the corrugation (9) increases as getting far from the center. The height of corrugation (9) may differ independent of the width. In addition, the corrugations may also be formed in different width and height values.

The reflective surface with latitudinal channels (10), similar to the reflective surface with longitudinal channels (8), consists of preferably convex corrugations (9) arranged in parallel to each other. The width and height of the corrugations (9) may be formed in different sizes as the case for other reflective surfaces.

The hog-backed (6) reflective surface (2), and the reflective surface (2) with longitudinal (8) and latitudinal (10) channels, exemplified above, are developed not only to provide a homogeneous illumination at a uniform light intensity on the area to be illuminated, but also to minimize the glaring effect.

With reflective surfaces (2) in question using Standard light source, however, although partly homogeneous illumination can be obtained, it is impossible to obtain a uniform illumination on the entire area. Therefore, the light source to be used should also have such technical characteristics that are capable of guiding the light energy to the area to be illuminated at required intensity, best fitting to the curvatures of the reflective surfaces (2), in order to obtain a fully homogeneous illumination at a uniform light intensity on the proposed area.

The armature reflective surfaces (2) hereunder can be used all standard light sources known, and partially homogeneous illumination can be obtained. However, the reflective surfaces (2) in question are mainly used with stepped light sources to provide the area to be illuminated with light energy at required light intensity and a fully homogeneous illumination at a uniform light intensity.

For the purpose of decreasing the glaring effect, the light beams being reflected from the armature are guided by the reflective surfaces (2) only towards the illumination area where they are positioned, thereby preventing the light from the reflective surfaces, which are visible even outside the illumination area from reaching at the eye.

According to fundamental rules of physics, a point light source placed on the focal point of a parabolic, cylindrical or spherical reflective surface can illuminate an area which is as large as the reflective surface. A point light source placed between the focus and reflector, however, can illuminate a larger area.

According to the fundamental rules of physics, explained above, a standard linear light source placed along the optical axis of the reflector can illuminate a very large area. However, the light intensity to be obtained as a result of generation of light energy by the said known standard linear light sources at uniform light intensity at the focal point and near the reflective surface can not be distributed over the illumination area homogeneously.

The stepped light source (3) resembles, by its structure a linear light source rather than a point light source, and is positioned such that one end is close to the focal point of the reflector, whereas the other end preferably close to the reflective surface (2). In addition, the light intensity values achieved by the stepped light source (3) are different along the optical axis of the reflective surface (2), and increases from the focal point towards the reflective surface (2).

In order to achieve the technical developments aimed by this invention, the light source (3) to be used with the armature (1) is positioned on the optical axis of the reflective surface (2) of the armature (1), and maximum amount of light energy is transmitted from its end close to the reflective surface (2) of the stepped light source (3) to the illumination area, whereas minimum amount of light energy is transmitted from its end close to the focal point of the reflective surface. As a result, lower amount of light energy reaches to the parts of the proposed area close to the armature (1), whereas higher amount of light energy reaches to its farther parts, thus the light beams being guided so that a uniform illumination is obtained on the entire area.

Furthermore, the energy losses that may be caused by back reflection due to indispensable technical characteristics of the armature (1) are also minimized by virtue of an auxiliary reflector (5) positioned behind the location where the stepped light source (3) is installed in the armature (1).

A rear internal reflector (18) mounted on the rear internal part of the light source (3) is intended to minimize the energy loss. In addition, a front reflector (4) to be placed in front of the stepped light source (3), whether inside or outside, may further decrease the glaring effect by preventing the light source from being visible directly.

Another reflective surface and light source hereunder are the multi-angle reflector (111) and the linear light source (12). The linear light source (12) contains a light source (12), having preferably triangular-section gas discharge tube, placed along the illumination axis (14). The multi-angle reflector (11) is in the form of a bowl having reflectors (15) which are symmetrical with respect to the illumination axis (14) of the light source (12) it uses and reflective panels (13) placed on both sides at different angles. Each of the panels (13) placed mutually with the concave reflective surfaces (15) located on both sides of the illumination axis (14) illuminates a different illumination zone.

The concave reflectors (15) may be placed at various angles with each other depending on the size and dimensions of the area to be illuminated. In the preferred application of the invention, however, the concave reflectors (15) are placed within an angle range of between 90-160°. Similarly, the panels (13) may also be placed at various angles depending on the size of the illumination area and the location where the armature is installed. However, the said reflective panels (13) are preferably placed at an angle range of between 20 and 70° with the illumination axis (14).

It is possible to change the amount of light energy by changing the size and position of the concave reflectors (15) used for illumination of farther parts of the illumination area and the panels (13) used for illumination of parts close to the armature (1), and through operations on the reflective surfaces. The surfaces of the panels (13) and concave reflectors may be mounded (7), projected (9), flat, channeled, hollowed or a combination thereof or freely inclined. Hence, it is possible to guide the light energy depending on the shape of the proposed illumination or the required light intensity, thereby providing a homogeneous illumination even in areas having different shapes and sizes, and minimizing the glaring effect.

As well as the multi-angle reflector (11) can be used with a stepped light source (3) placed along the optical axis, it can also be used a linear light source (12), which can be defined, by its technical characteristics, as triangular prism with isosceles section. The said linear light source (12) provides increasing light intensity from the top to bottom as the stepped light source (3). As well as the linear light source (12) can have an equilateral triangle section, it can also have a long isosceles triangle section with its top facing outside through the armature (1) opening. The position of the linear light source (12) is similar to the position of the stepped light source (3) as the base of the discharge tube with isosceles triangular shape is close to the multi-angle reflector (11), and its top intersection (19) is far from the reflector (11) on the optical axis.

The linear light source (12) is surrounded by panels (13), concave reflectors (14) and auxiliary reflectors (5) so that it is not visible on the external opening of the armature outside the proposed illumination area and in order to provide the most efficient illumination. It is intended to minimize glaring. In addition, this type of linear light source (12) positioning makes it possible to provide the illumination area with higher light intensity from the base of the discharge tube which is close to the reflective surfaces, whereas less from the top intersection (19).

The concave reflectors (15) and reflective panels (13) are placed so that they illuminate the side they are located with respect to their positions in the armature. However, it is not possible always to mount the armature (1) having a multi-angle reflector (11) at the center of the illumination area. Particularly in road illumination, since the lighting armature is installed on the masts along the road edges, the said reflective panels (13) may not allow a uniform light intensity, as they illuminate only the side they are located. This problem can be overcome by positioning the panels (13) at different angles, and adjusting them so that they can illuminate more than one zones.

An auxiliary reflector (5) inside the armature (1) using a multi-angle reflector (11) is the part falling between the concave reflectors (15) and surrounding the linear light source (12). The auxiliary reflector (5) consists of two auxiliary reflectors (16) making an angle of preferably 90-160 degrees with each other and an auxiliary convex reflector (17) falling between them.

Each of the auxiliary concave reflectors (16) is positioned such that it reflects the light beams being reflected back from the linear light source (12) towards the farthest parts of the illumination zone opposite the position it is located.

All of the light reflected from the auxiliary concave reflectors (16) and in opposite direction comes from the back of the discharge tube of the light source, therefore all of the light beams being reflected therefrom remains within the illumination zone. Therefore, any observer or driver looking from outside the illumination zone cane face no light beam as he/she can not see these surfaces, and thereby causing no glaring as a result of back reflection from these surfaces.

The auxiliary convex reflector (17) causes the linear light source (12) to appear virtually behind the armature (1). The auxiliary convex reflector (17) ensures that the beams reflected from the virtual light source are guided to a large area at the center of the illumination zone, by minimizing the obstruction by the linear light source (12).

Furthermore, it is possible with an armature (1) with a multi-angle reflector (11) to minimize the energy losses caused by backward light scattering due to technical characteristics of the armature (1) by virtue of an additional auxiliary reflector (5) to be placed behind the location where the linear light source is mounted.

In the preferred application, the concave reflectors (15) and panels (13) are angled in two steps. However, the surfaces of concave reflectors (15), panels (13) and auxiliary reflectors (5) may contain two or more steps, or each of these reflective surfaces may consist of a single-piece convex, flat or concave surfaces having different reflection angles in themselves, or different combinations thereof.

The reflective surfaces (2) in the armature (1) hereunder can be made of any reflective material known and used in the floodlights. However, manufacturing of the stepped light source (3) presents some differences when compared to the known standard light sources due to some technical characteristics it comprises. As also explained above, the stepped light source (3) is a linear one and has a light intensity increasing from one end towards the other. For this purpose, it is a light source (3) where at least 2 gas discharge tubes are arranged sequentially, and each part of the light sources with sequential discharge tubes may have the same or different dimensions. In addition, it is also possible to apply linear or stepped light sources with conical filament, conically shaped fluorescent or conical LED (Light Emitting Diode). For this purpose, a stepped light source (3) in which the filament winding diameter increases from one end towards the other or the LEDs are placed conical can be obtained, or independent of the structure and size, the light sources with discharge tube, filament or LED, having lumen values increasing from one end to the other can be applied.

In addition, another application of this invention is an armature (1) in which the stepped light source (3) is used with more than one reflective surface (2) mounted in one another. In this type of armatures, the reflector having the narrowest angle and located at the innermost position guides the light energy at the end of the stepped light source having the lowest lumen value towards the center of the illumination area. Each of other reflectors sequenced backwards has wider reflection angle respectively, and the light energy at the middle of the discharge tube of the light source with medium lumen value is reflected by the reflector at the middle, and the light energy having the highest lumen value behind the discharge tube reflected by the largest reflector located at the rearmost and outermost position towards the farthest parts of the area, thereby guiding the light energy towards the parts of the area far from the armature in larger proportions, and towards the parts close to the armature in lower proportions ensuring a homogeneous illumination on the entire proposed area.

Another structure in which such multiple reflectors are used is the application in which the reflective surfaces (2) are arranged sequentially being at least two units from the end to the bottom inside or outside the stepped light source (3). In this application, the reflective surfaces on the same optical axis and having different focal distances can be positioned so that they illuminate different zones in the illumination area, and the reflective surfaces (2) can be positioned such that each reflective surface presents little or no obstruction for the light beams being reflected from the one behind it.

As well as such reflective surfaces (2) can be the reflectors surrounding the stepped light source (3), they may also be the reflectors inside the stepped light source (3). By this virtue, it is possible to use the stepped light source (3) as an armature (1) providing a homogeneous illumination by itself.

The armature (1) hereunder, detailed above and illustrated in the figures can not be limited to the applications described in the claims below. It is possible to use the invention in many different applications, provided that the same technical characteristics are maintained.

1. An armature comprising at least one reflective surface, and a stepped light source which is embodied so that its one end is close to the focal point of said reflective surface, and the other end is close to said reflective surface and it has a light intensity increasing from the focal point towards the reflective surface.

2. An armature according to claim 1, wherein said stepped light source is placed along the optical axis of the armature.

3. An armature according to claim 1, wherein a front reflector is placed in front of the stepped light source, preventing uncontrolled illumination by the light source, and preventing the light source from being visible directly from outside.

4. An armature according to claim 1, wherein a rear internal reflector is placed at rear inside part of the stepped light source, guiding the light beams scattering back from the light source towards the illumination area.

5. An armature according to claim 1, wherein an auxiliary reflector is positioned behind the location where the stepped light source is mounted on the armature, gathering the light beams being back reflected from the light source and armature and transmitting them to the illumination area.

6. An armature according to claim 1, wherein said reflective surfaces guide the light beams being reflected from the armature only towards the illumination area where they are positioned, thereby prevents the light from the reflective surfaces, which are visible even outside the illumination area from reaching at the eye.

7. A stepped light source according to claim 1 wherein, in order to obtain homogenous and maximum amount of light energy, wherein said stepped gas discharge light source has minimum light energy close to the focal point of said reflective surface, and maximum light energy close to the reflective surface independent of the structure and size.

8. A stepped light source which has a light intensity increasing from one end towards the other, comprises at least one gas discharge tube having at least one-node and a single gas discharge opening.

9. A stepped light source according to claim 8, wherein it has multiple gas discharge openings.

10. A stepped light source according to claim 8, wherein at least one sequential reflector is mounted inside the light source between the gas discharge nodes or openings.

11. A stepped light source having a light intensity increasing from one end towards the other, comprising a conical gas discharge tube having a larger radius on its base (the beginning end) than its head (the other end).

12. A stepped light source having a light intensity increasing from one end towards the other, comprising Light Emitting Diodes (LED) placed conically or arranged around a winding which its diameter increases one end towards the other independent of the structure and size.

13. A stepped light source having a light intensity increasing from one end towards the other, comprising at least one filament winding in a shape of a tube having at least one node independent of the structure and size.

14. A linear light source providing increasing light intensity from the top to bottom comprises at least one triangular-section gas discharge tube placed along the illumination axis of said light source.

15. A linear light source according to claim 14, comprising an opening as triangular prism with isosceles section.

16. A linear light source according to claim 14, comprising an equilateral triangle section or a long isosceles triangle section with its top facing outside through an armature opening.

17. A linear light source providing increasing light intensity from the top to bottom according to claim 7.

18. An armature, to be used in all indoor and outdoor lighting applications, characterized by a multi angle reflector containing two reflector sections parallel to the illumination axis, two panels positioned at an angle of between 20° to 70° with the illumination axis, two auxiliary reflector sections making an angle of between 90° to 160° with the illumination axis, and an auxiliary reflector section falling between them.

19. A multi angle reflector reflecting light beams coming from a light source so as to provide a uniform illumination, maximum photometric performance and minimum glaring effect characterized by at least one reflector section which is placed in a proper angle depending on the size and dimensions of the far and near sections of the illumination area and at least one auxiliary reflector section which illuminates the farthest sections of said area and at least one auxiliary reflector section placed between the two reflector sections to illuminate said near sections of the illumination area and at least one panel which is positioned to illuminate the opposite section of said area.

20. A multi angle reflector according to claim 19, wherein said reflector section has an upper part to illuminate said far sections of said illumination area and has a lower part to illuminate said near sections of said illumination area.

21. A multi angle reflector according to claim 19, wherein said auxiliary reflector sections are positioned such that it reflects the light beams being reflected back from the light source towards the farthest sections of the illumination area opposite the position where it is located.

22. A multi angle reflector according to claim 19, wherein said auxiliary reflector section ensures that the light beams reflected from the light source are guided to a large area at the center of the illumination area, by minimizing the obstruction by the linear light source.

23. A multi angle reflector according to claim 19, wherein an additional auxiliary reflector is placed behind the location where the light source is mounted to minimize the energy losses caused by backward light scattering.

24. A multi angle reflector according to claim 19, wherein said reflector sections and panel are multiple piece, flat, concave, convex and/or free form surface to illuminate different locations or sections of said illumination area.

25. A method for obtaining uniform illumination, maximum photometric performance and minimum glaring effect which is used in an armature comprising at least one reflective surface, wherein using a stepped light source the method comprises the steps of: transmitting a maximum amount of light energy from its end close to said reflective surface of said stepped light source to the illumination area, and
transmitting a minimum amount of light energy from its end close to the focal point of the reflective surface so that a lower amount of light energy reaches to the parts of the proposed area close to the armature, and so that a higher amount of light energy reaches to its farther parts.

26. A method for obtaining uniform illumination, maximum photometric performance and minimum glaring effect which is used in an armature comprising at least one reflective surface, wherein using a multi angle reflector, the method comprises guiding light beams towards an illumination area and illuminating the farthest sections of the illumination area with auxiliary reflector sections, the near sections of the illumination area with a lower part and the far sections of the illumination area with an upper part of a reflector.
